(19) United States
(12) Patent Application Publication
(10) Pub. No.: US 2011/0187244 A1
(43) Pub. Date: Aug. 4, 2011

(54) SYSTEMS AND METHODS FOR MATTRESS DISPLAY DEVICES

(75) Inventor: Matthew Gilbert Schachte, Cumming, GA (US)

(73) Assignee: Dreamwell, Ltd., Las Vegas, NV (US)

(21) Appl. No.: 13/015,785

(22) Filed: Jan. 28, 2011

Related U.S. Application Data
(60) Provisional application No. 61/337,062, filed on Jan. 29, 2010.

(51) Int. Cl. A47F 3/00; G09F 3/00

(52) U.S. Cl. 312/114; 40/299.01

(57) ABSTRACT

A mattress display device includes a mattress, a housing having a mounting flange and a plurality of coil springs, and a rigid panel. The housing may include an opening in its top surface. The mounting flange may be disposed on the housing, and may be configured to attach to a portion of the mattress. The coil springs may be disposed within the housing such that their bottom ends are in substantially the same plane. The top end of a coil spring may be exposed via the opening in the top surface. The mattress display device may include a rigid panel sized to slide through the opening in the top surface. The rigid panel may allow the customer to experience visual and tactile responses related to the mattress by, e.g., operating the rigid panel to compress the coil springs exposed via the opening.

### CROSS-REFERENCE TO RELATED APPLICATIONS

This application claims priority to and the benefit of U.S. Provisional Patent Application Ser. No. 61/337,062, filed Jan. 29, 2010 and entitled “Systems and Methods for Mattress Display Devices”, the entire contents of which are incorporated herein by reference.

### FIELD OF THE INVENTION

The systems and methods described herein relate to customer assistance display devices for cushioning articles, and more specifically to mattress display devices.

### BACKGROUND

Modern mattresses are manufactured to include many different technologies. For example, mattresses may incorporate a traditional or pocketed coil technology, or foams made from polyurethane or latex. Similarly, mattresses may include different types of mattress topper pads, side panels, and additional upholstery and non-upholstery layers. A consumer intending to purchase a new mattress may be intimidated by the different choices of mattress technology available. In addition, it may be difficult for a consumer in a showroom or a consumer at a trade show to determine the type of technology used in a particular mattress simply by looking at the mattress.

Accordingly, there is a need for a system that allows a consumer to be able to easily discern and view the technology used in a mattress.

### SUMMARY

The systems and methods described herein are directed to mattress display devices, and more generally, customer assistance display devices for cushioning articles. For purposes of clarity, and not by way of limitation, the systems and methods may be described herein in the context of providing mattress display devices. However, it may be understood that the system and methods described herein may be applied to provide for any type of cushioning article, such as pillows, blankets, or pads.

In one aspect, the systems and methods described herein provide for a mattress display device for providing visual and tactile responses related to a mattress to a customer. The mattress display device may include a mattress, a housing having a mounting flange and a plurality of coil springs, and a rigid panel. The housing may have a front substantially transparent surface, a back surface, a top surface, and a bottom surface. The housing may have side surfaces extending between the front and back surfaces and the top and bottom surfaces. The top surface may include an opening. The mounting flange may extend outwardly from the back surface or the side surfaces. The mounting flange may be configured to attach to a portion of the mattress. The coil springs may be similar to one or more coil springs in the mattress. Each coil may have a top end and a bottom end. The coil springs may be disposed within the housing such that the bottom ends of the coil springs are in substantially the same plane and the coil springs are arranged adjacent to one another. The top end of a coil spring may be exposed to the customer via the opening in the top surface. The mattress display device may include a rigid panel sized to slide through the opening in the top surface of the housing. The rigid panel may be formed from rigid material capable of compressing one or more coil springs. The rigid panel may allow the customer to experience the visual and tactile responses related to the mattress by, for example, compressing the coil springs exposed via the opening in the top surface of the housing.

In some embodiments, the side surfaces of the mattress display device may have a width corresponding to two or more coil springs placed beside each other. In some embodiments, the mattress display device may include a label disposed on the housing, the coil springs, and/or the rigid panel. The label may include a name of a technology, a technical specification of the technology, and/or a description of a property of the technology. In some embodiments, the mattress may be disposed on a foundation of a mattress assembly, and the mounting flange may be inserted between the mattress and the foundation.

In some embodiments, the mattress display device includes a plunger disposed within the housing. The plunger may have a base, a spring activated stem attached to the base for movement relative to the base, and a coil spring disposed on the plunger. The plunger may be configured to allow the customer to compress the top end of the coil spring by operating the plunger. In some embodiments, the mattress display device includes a fire-retardant layer, a liquid-resistant layer, and/or an allergy-resistant layer. The layers may be disposed on the coil springs. The layers may be accessible via the opening in the top surface of the housing, which may allow the customer to remove or replace one or more layers via the opening.

In some embodiments, the coil springs includes an open coil spring, an encased coil spring, and/or an asymmetric coil spring. The coil springs may be disposed in the housing may be less than number of coil springs in the mattress. The coil springs may include a coil spring having a height different from the rest of the coil springs. In some embodiments, the coil springs includes a matrix of coil springs arranged in rows and columns. In some embodiments, one or more foam blocks is disposed within the housing. A top end of a foam block may be exposed to a customer via the opening in the top surface of the housing.

In some embodiments, the rigid panel includes at least one edge curved to mimic the shape of a prone human body. The mattress display device may optionally include a storage slot for storing the rigid panel. The rigid panel may be formed from at least one of plastic, wood, and cardboard.

In another aspect, the systems and methods described herein provide for a mattress display device for providing visual and tactile responses related to a mattress to a customer. The mattress display device includes a housing having a top substantially transparent surface, a bottom surface, a front surface, and a back surface. The housing may have side surfaces extending between the top and bottom surfaces and the front and back surfaces. The mattress display device may include a plurality of coil springs disposed within the housing, and arranged in rows and columns. The coil springs may be similar to one or more coil springs in a mattress and may be less than number of coils in the mattress. Each coil spring may have a top end and a bottom end. The top surface of the housing may include an opening to expose the top end of a coil spring to the customer.

In yet another aspect, the systems and methods described herein provide for a method for of allowing a user to experience visual and tactile responses related to a mattress to a customer. A mattress may be provided, and a housing may be disposed on a side of the mattress. The housing may have a front substantially transparent surface, a back surface, a top surface, and a bottom surface. The housing may have side surfaces extending between the front and back surfaces and the top and bottom surfaces. The top surface of the housing may include an opening. A plurality of coil springs may be disposed within the housing. The coil springs may be similar to one or more coil springs in the mattress. Each coil may have a top end and a bottom end. The top end of a coil spring may be exposed to the customer via the opening in the top surface of the housing. In certain embodiments, the opening in the top surface may have an area about half the area of the top surface. In other embodiments, the opening in the top surface may have an area that is greater than or less than half the area of the top surface. The opening may be suitable sized and shaped as desired without departing from the scope of the invention.

In some embodiments, a label may be disposed on the housing and/or the coil springs. The label may include a name of a technology, a technical specification of the technology, and/or a description of a property of the technology. In some embodiments, the housing may be disposed on a side of the mattress by inserting a mounting flange between the mattress and a foundation of a mattress assembly. The mounting flange may be disposed on the housing and extending outwardly from the back surface or the side surfaces of the housing. In some embodiments, a rigid panel may be provided to allow the customer to experience the visual and tactile responses related to the mattress by, for example, compressing the plurality of coil springs disposed in the housing with the rigid panel. The rigid panel may be sized to slide through the opening in the top surface. The rigid panel may be formed from rigid material capable of compressing one or more coil springs.

In some embodiments, a plunger may be disposed within the housing. The plunger may have a base and a spring activated stem attached to the base for movement relative to the base. A coil spring may be disposed on the plunger. The plunger may allow the customer to compress the top end of the coil spring by operating the plunger. In some embodiments, a fire-retardant layer, a liquid-resistant layer, and/or an allergy-resistant layer may be disposed on the coil springs. The layers may be accessible via the opening in the top surface of the housing, which may allow the customer to remove or replace one or more layers via the opening. In some embodiments, one or more foam blocks may be disposed within the housing. The opening in the top surface of the housing may expose a top end of a foam block to the customer.

### BRIEF DESCRIPTION OF THE FIGURES

The foregoing and other objects and advantages of the systems and methods described herein will be appreciated more fully from the following further description thereof, with reference to the accompanying drawings wherein;

FIG. 1 depicts a customer assistance display device, according to an illustrative embodiment;

FIG. 2A depicts a mattress display device for coil springs having a plunger, according to an illustrative embodiment;

FIG. 2B depicts a mattress display device for coil springs, according to another illustrative embodiment;

FIGS. 3A-B depict an exemplary rigid panel in operation with a mattress display device for coil springs, according to yet another illustrative embodiment;

FIG. 4 depicts a mattress display device for coil spring arrays, according to an illustrative embodiment;

FIGS. 5A-B depict a mattress assembly with a mounted mattress display device, according to an illustrative embodiment;

FIG. 6 is a flowchart depicting a process for providing a mattress display device, according to an illustrative embodiment; and

FIG. 7 depicts a mobile exhibiting structure with a mounted mattress display device, according to an illustrative embodiment.

### DETAILED DESCRIPTION

In many aspects, the systems and methods described herein provide mattress display devices that provide visual and tactile information to customers about mattress and/or cushioning article technology. The mattress display device may include a translucent or transparent housing. One or more particular portions of a mattress or cushioning articles may be included within the housing of the mattress display device, such that a customer is able to view the portions of the mattress or cushioning articles or the technology incorporated within these. The mattress display device may be configured to include different portions of a mattress or cushioning article, or to include different examples of technology that may be incorporated into a mattress or a cushioning device. The mattress display device may include one or more actuators or plungers by which a customer may compress or actuate the included portion of the mattress or cushioning article. Optionally, the housing of the mattress display device may include one or more openings via which a customer may directly touch, compress, and/or actuate the included portion of the mattress or cushioning article. The mattress display device may be configured as a standalone unit, or may be configured to attach to a mattress or a cushioning article. In some embodiments, the mattress display device may include a label or another display device, which provides information about a mattress, a cushioning article, or mattress/cushioning article technology to a customer.

To provide an overall understanding of the systems and methods described herein, certain illustrative embodiments will now be described, including mattress display devices that provide information to customers about mattress and/or cushioning article technology. However, it will be understood by one of ordinary skill in the art that the systems and methods described herein may be adapted and modified for other suitable applications and that such other additions and modifications will not depart from the scope thereof.

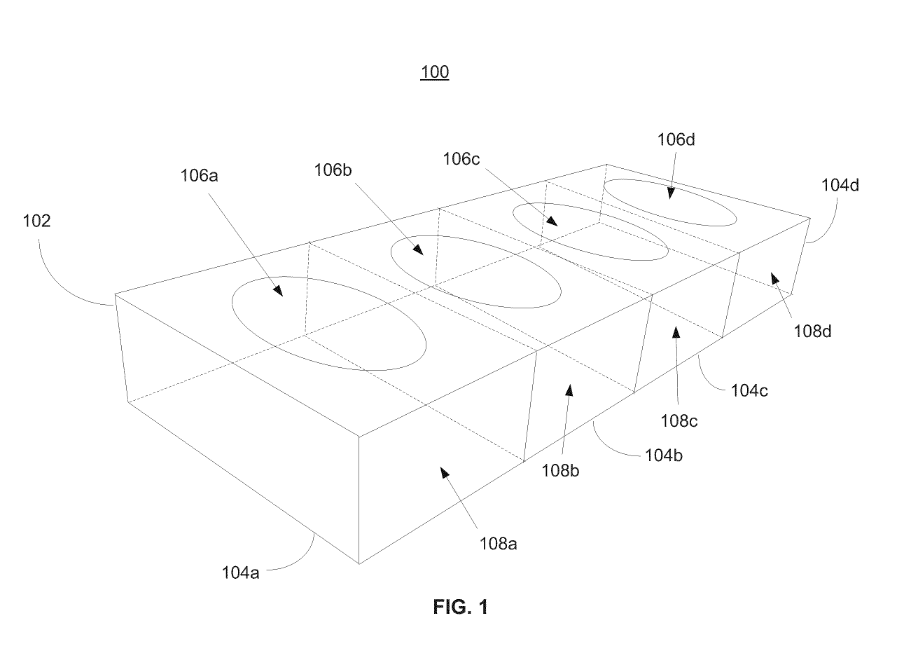

FIG. 1 depicts a mattress display device 100, according to an illustrative embodiment. Mattress display device 100 includes a housing 102, which may be fabricated at least partly of a transparent and/or translucent, rigid material. The housing 102 may have a front substantially transparent surface, a back surface, a top surface, and a bottom surface. The housing 102 may have side surfaces extending between the front and back surfaces and the top and bottom surfaces. The interior of housing 102 may be divided into one or more display regions 104a-d. In some embodiments, each display region 104a-d may include a different type of mattress or cushioning article technology for display to a customer. In one embodiment, display regions 108a-d may each contain a portion of a particular type of foam, and each display region may contain foam block of a different type of foam. For example, display region 104a may contain a foam block that has a lower ILD than the foam blocks in display regions 104b-d, display region 104b may contain a foam block that has a lower ILD than the foam blocks in display regions 104c-d, and display region 104c may contain a foam block that has a lower ILD than the foam block contained in display region 104d. In other embodiments, the display regions 104a-d may contain different types of mattress technology. For example, instead of or in addition to foam, display regions 104a-d may include different types of upholstery, fabric, mattress/cushioning article layers, or any other component of a mattress or cushioning article.

While four display regions are shown in FIG. 1, in other embodiments the interior housing 102 may be divided into more or fewer display regions. In some embodiments, the display regions within the interior housing 102 are separated from each other by internal dividing walls. In other embodiments, a single piece of foam may span two or more of the display regions, with the foam in different display regions processed with different methods. For example, the portion of the single piece of foam in display region 104a may be processed in one way, and the portion of the single piece of foam in display region 104b may be processed in another way. In these embodiments, there may be no internal dividing wall within the interior housing 102.

In some embodiments, housing 102 includes one or more apertures or openings 106a-d. Each of the openings 106a-d correspond to one of the display regions 104a-d. The openings 106a-d may allow a customer or a user to physically touch or actuate the mattress or cushioning article technology contained within the display regions 104a-d. Thus, a customer or user may be able to experience the different physical properties of the various types of mattress or cushioning article technology being displayed.

Mattress display device 100 also includes information regions or labels 108a-d, each corresponding to one of the display regions 104a-d. Each label 108a-d may provide information about the mattress or cushioning article technology contained within the corresponding display region. For example, each label may include the name of the particular technology, technical specifications about the technology, and/or a description of the properties of the technology. The information in labels 108a-d may be written and/or drawn directly onto the surface of housing 102, or may be contained in a sticker, tag, or other information sheet that may be attached to the surface of housing 102.

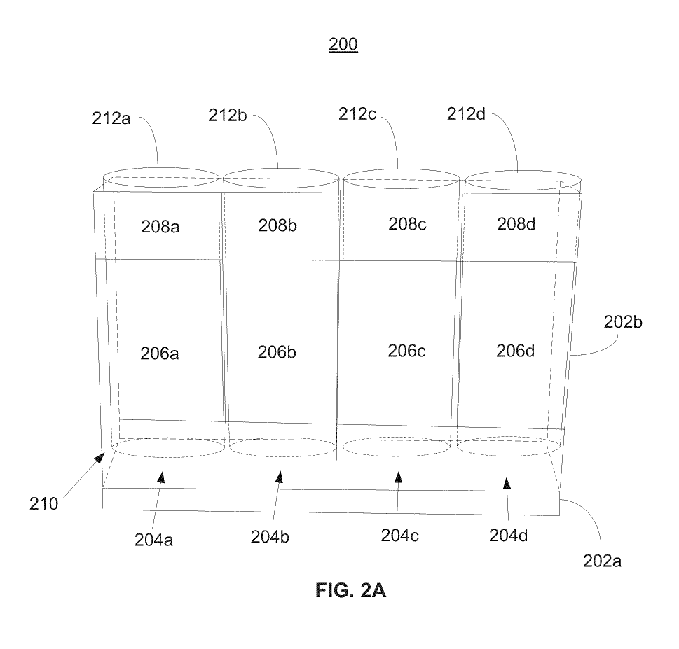

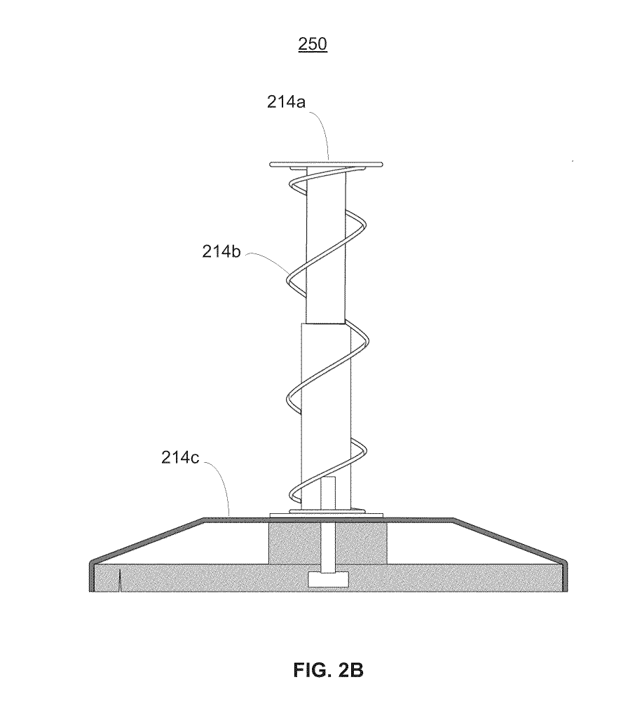

FIG. 2A depicts a mattress display device 200, according to one illustrative embodiment. Mattress display device 200 includes a base 202a and a housing 202b, each of which may be fabricated of a rigid material. In some embodiments, base 202a may be opaque, and housing 202b may be translucent or transparent. The housing 202b may have a front substantially transparent surface, a back surface, a top surface, and a bottom surface. The housing 202b may have side surfaces extending between the front and back surfaces and the top and bottom surfaces. In some embodiments, the side surfaces may have a width corresponding to two or more coil springs placed beside each other. In other embodiments, mattress display device 200 may not include housing 202b.

Mattress display device 200 may provide one or more display regions, such as display regions 204a-d. Although mattress display device 200 is shown in FIG. 2A as providing four display regions 204a-d, in other embodiments mattress display device 200 may provide more or fewer display regions. The different display regions may be separated from each other by one or more dividers such as internal compartment walls. In some embodiments, one or more of the different display regions may be merged into a continuous region. Each of the display regions 204a-d may include a different type of mattress or cushioning article technology. In the embodiment shown in FIG. 2A, each of the display regions 204a-d contains a coil spring 206a-d, such as an unencased or open coil spring, an encased coil spring, and/or an asymmetric coil spring. In some embodiments, the coil springs disposed in the housing may be less than number of coil springs in a mattress. In some embodiments, the coil springs may include a coil spring having a height different from the rest of the coil springs. In some embodiments, the coil springs may include a matrix of coil springs arranged in rows and/or columns. In some embodiments, the coil spring in each display region may differ from the coil spring in any other display region. For example, coil spring 206a may have different characteristics than any of coil springs 206b-d, coil spring 206b may have different characteristics than any of coil springs 206c-d, and coil spring 206c may have different characteristics than coil spring 206d.

The mattress display device 200 may include one or more information regions or labels 208a-d and 210 to provide information about the mattress or cushioning article technology contained within the corresponding display region or displayed by the mattress display device as a whole. For example, each label may include the name of the particular technology, technical specifications about the technology, and/or a description of the properties of the technology. The information in labels 208a-d and 210 may be written and/or drawn directly onto the surface of housing 202b, or may be contained in a sticker, tag, or other information sheet that may be attached to the surface of housing 202b. In embodiments of mattress display device 200 without a housing 202b, labels 208a-d and/or 210 may be disposed on the base 202a.

In the embodiment shown in FIG. 2A, mattress display device 200 is configured to expose the top portions 212a-d of coil springs 206a-d to a customer or user via an opening in the housing 202b. In embodiments without the housing 202b, the coil springs 206a-d will be naturally exposed. A customer or user may touch, compress, and/or actuate the top portions 212a-d to gauge the physical characteristics of the coil springs 206a-d, such as their compressive and resilience characteristics. In some embodiments, one or more of coil springs 206a-d may include one or more plungers (shown in FIG. 2B) to allow a user to more easily compress or actuate the coil springs. Plunger 250 includes a base 214c and a spring activated stem 214a attached to the base 214 for movement relative to the base. A coil spring 214b is disposed on the stem 214a of the plunger 250. Plunger 250 may allow a user to compress the top end of the coil spring 214b by operating the plunger 250 via stem 214a. In some embodiments, plunger 250 may be a stand-alone mattress display device.

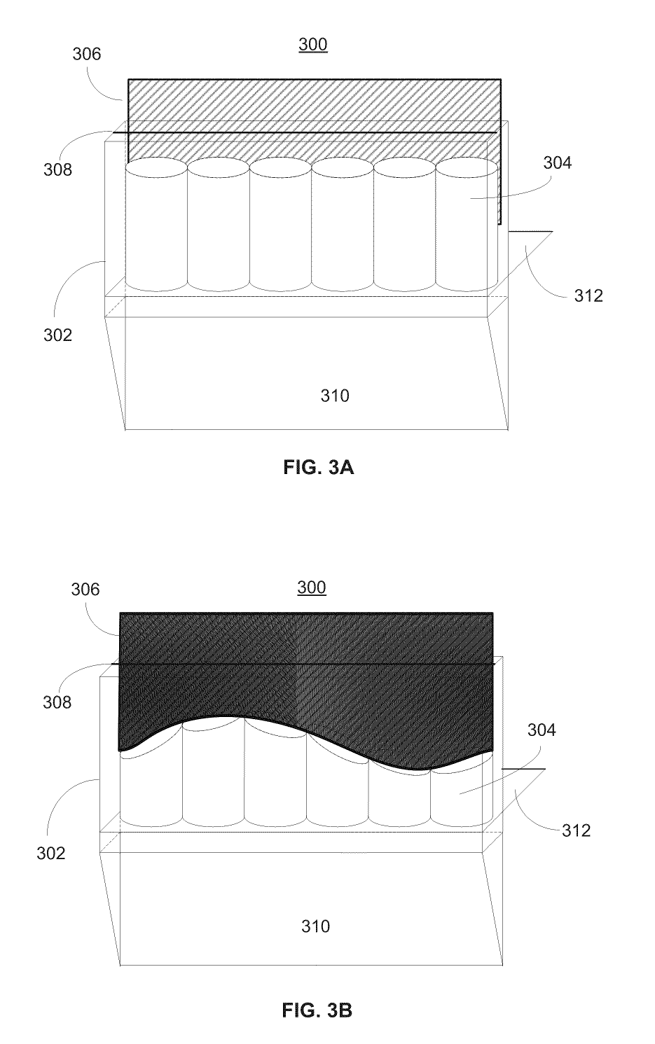

FIGS. 3A-B depict a mattress display device 300, according to an illustrative embodiment. Mattress display device 300 includes a housing 302, which may be fabricated of a rigid, translucent/transparent material. The housing 302 may have a front substantially transparent surface, a back surface, a top surface, and a bottom surface. The housing 102 may have side surfaces extending between the front and back surfaces and the top and bottom surfaces. In some embodiments, the side surfaces may have a width corresponding to two or more coil springs placed beside each other. The housing 302 may be mounted on, near, or next to mattress or a mattress/foundation combination. The housing 302 may define an interior region, which may be divided into one or more display regions. The interior region or display regions may contain mattress or cushioning article technology. In the embodiments shown in FIGS. 3A-B, the interior region contains a row of coil springs, such as unencased, encased, and/or asymmetric coil springs. The coil springs may be similar to one or more coil springs in the mattress. The coil springs may have top ends and bottom ends. The coil springs may be disposed within the housing such that the bottom ends of the coil springs are in substantially the same plane and the coil springs are arranged adjacent to one another.

The mattress display device 300 includes a compression demonstrator or substantially rigid panel 306, which may be stored, for example, in a storage slot behind housing 302. The housing 302 may also include one or more apertures or openings 308 configured to allow the rigid panel 306 to access the interior region of the housing 302. While the mattress display device 300 may operate as a standalone unit, in some embodiments, housing 302 may include a support 310 and/or a mounting flange 312 to allow the mattress display device 300 to be mounted on, near, or next to a mattress or a mattress/foundation combination. For example, mounting flange 312 may be inserted between the mattress and foundation of a mattress/foundation combination to hold and stabilize housing 302.

The rigid panel 306 is shown in a stored state in FIG. 3A. FIG. 3B shows the rigid panel 306 in use. In some embodiments, the rigid panel 306 may be fabricated of a substantially rigid material, such as wood, cardboard, or plastic. The rigid panel 306 may be sized and shaped such that it fits through the opening 308. The top end of a coil spring may be exposed to a customer via the opening 308. In certain embodiments, at least one edge of the rigid panel 306 may be curved to, for example, mimic the shape of a prone human body. A customer may place the rigid panel 306 through the opening 308 with the shaped edge facing downwards, and apply force to push the rigid panel down onto the row of coil springs 304 or other mattress technology component(s) in the interior region of housing 302. Thus, the customer may be able to compress or actuate the row of spring coils 304 to see, through the transparent/translucent housing 302, the compression characteristics of the coil springs 304.

In some embodiments, mattress display device 300 may include one or more information regions or labels. The labels may provide information about the mattress or cushioning article technology contained within the display device. For example, a label may include the name of the particular technology, technical specifications about the technology, and/or a description of the properties of the technology. The labels may be disposed on housing 302, support 310, the rigid panel 306, and/or the coil springs 304. The information in the labels may be written and/or drawn directly onto a surface, or may be contained in a sticker, tag, or other information sheet that may be attached to a surface.

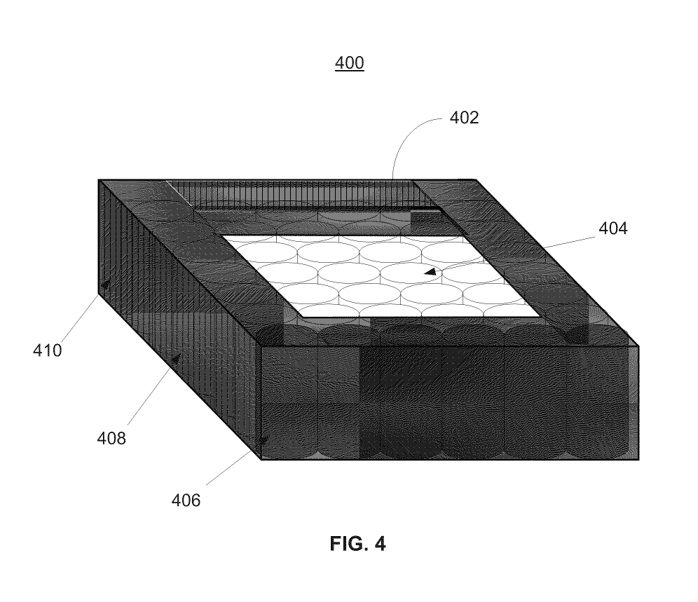

FIG. 4 depicts a mattress display device 400, according to an illustrative embodiment. Mattress display device 400 includes a housing 402, which may be made of a substantially rigid or somewhat flexible transparent/translucent material. The housing 402 may have a front substantially transparent surface, a back surface, a top surface, and a bottom surface. The housing 402 may have side surfaces extending between the front and back surfaces and the top and bottom surfaces. Mattress display device 400 may provide one or more display regions such as display regions 406-410. Although mattress display device 400 is shown in FIG. 4 as providing three display regions 406-410, in other embodiments mattress display device 400 may provide more or fewer display regions. The different display regions may be separated from each other by one or more dividers such as internal compartment walls, or may not be separated from each other at all. Each of the display regions 406-410 may include a different type of mattress or cushioning article technology. In the embodiment shown in FIG. 4, display regions 406 and 408 contain a row or array of coil springs, such as an unencased coil spring, an encased coil spring, and/or an asymmetric coil spring. Display region 410 contains a foam portion. The coil springs contained in display region 406 may differ from the coil springs contained in display region 408, in type and/or compressive characteristics. In some embodiments, the mattress display device 400 may include coil springs similar to one or more coil springs in a mattress, but less than number of coils in the mattress. The coil springs may be arranged in rows and columns.

Housing 402 may include one or more apertures or openings 404. The opening 404 may allow a customer or a user to physically touch, compress, and/or actuate the mattress or cushioning article technology contained within the display regions 406, 408, and 410. Thus, a customer or user may be able to experience the different physical properties of the various types of mattress or cushioning article technology being displayed. In some embodiments, housing 402 may be fabricated of two or more portions that fit together to form housing 402. In these embodiments, one of the portions of housing 402 may be removable to allow a customer or user greater access to the mattress or cushioning article technology contained within the housing 402. In some embodiments, the housing 402 may include one or more handles, to allow the mattress display device 400 to be transported with ease. Optionally, the mattress display device 400 may include one or more mounts to allow the mattress display device 400 to be mounted to a mattress, a mattress/foundation combination, or to any other support.

In some embodiments, mattress display device 400 may include one or more information regions or labels. The labels may provide information about the mattress or cushioning article technology contained within the display device. For example, a label may include the name of the particular technology, technical specifications about the technology, and/or a description of the properties of the technology. The labels may be disposed on housing 402 or on the mattress or cushioning article technology components in the display regions 406-410. The information in the labels may be written and/or drawn directly onto a surface, or may be contained in a sticker, tag, or other information sheet that may be attached to a surface.

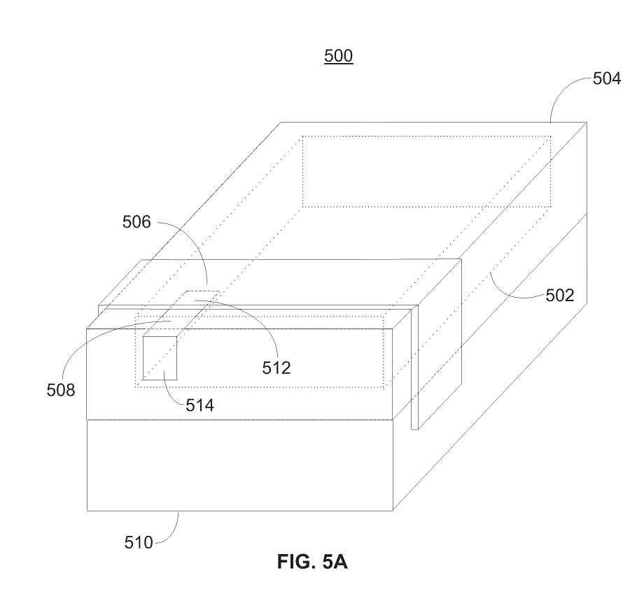

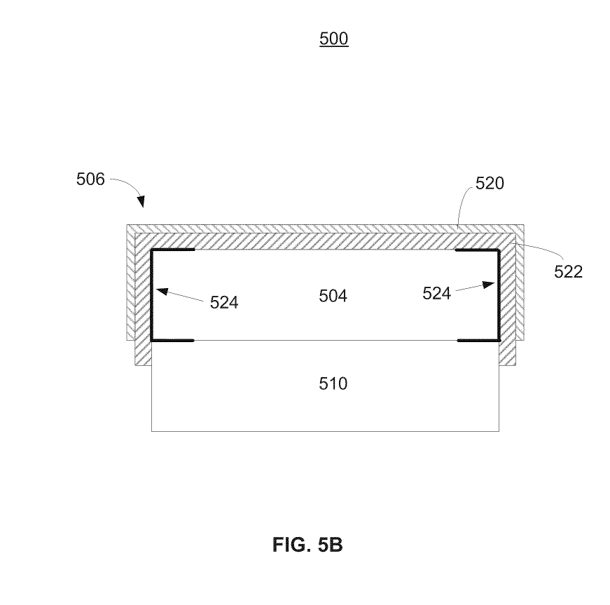

FIG. 5A depict a mattress assembly 500 with a mounted mattress display device 506, according to an illustrative embodiment. Mattress assembly 500 may include a mattress 504 and a foundation 510. Mattress 504 includes an innercore 502 that may include springs, such as coil springs or encased coil springs. These springs may be configured to provide foam-like compressive behavior. In certain embodiments, the innercore 502 may also include other support structures and materials, such as foam, latex, gel, viscoelastic gel, or a combination of the foregoing, in one or more layers. In other embodiments, the innercore 502 may not include any springs. The innercore 502 may have a firmness that varies across its length and width. Foundation 510 may include a mattress frame or mattress corner guards. The mattress frame may be adjustable, allowing the frame and/or mattress to pivot or bend along one or more pivoting axes.

In certain embodiments, mattress 504 may also include one or more side rails. The side rails may be placed on one side of the innercore 502, opposing sides of the innercore 502, on three adjacent sides of the innercore 502, or on all four sides of the innercore 502. In some mattress embodiments, the innercore 502 may not include springs, and the side rails may include coil or encased coil springs instead. In some of these embodiments, the springs may be configured to provide foam-like compressive behavior. In certain embodiments, the side rails may include edge supports with firmness comparable to or greater than the firmness of the innercore 502. The side rails may be fastened to the innercore 502 via adhesives, mechanical fasteners, or any other methods for attachment.

In some embodiments, mattress 504 may include a padding layer. The padding layer may be adjacent to the top surface of the innercore 502 or the bottom surface of the innercore 502. In some embodiments, mattress 504 may be a reversible mattress, in which the top surface and bottom surface in one configuration may be the bottom surface and top surface, respectively, in another configuration. In certain embodiments with side rails, the side rails may also be constructed in a reversible manner. In other embodiments, there may be a padding layer adjacent to the top surface and another padding layer adjacent to the bottom surface of the innercore 502. The padding layer may include foam, gel, or any other type of padding material, in one or more layers. In some embodiments, mattress 504 may include a topper pad that may define the top exterior surface of the mattress. This topper pad may include foam gel, or any other type of padding material, in one or more layers. In certain embodiments, the topper pad and/or the padding layer may be made of quiltable material. The topper pad may have a uniform height or thickness along its width and length, or its height or thickness may vary along at least one of the width and length. For example, the topper pad may be thicker in the center than at its periphery. In some embodiments, such as for a reversible mattress, a second topper pad may define the bottom exterior surface of the mattress. In certain embodiments, mattress 504 may include an exterior, removable cover. The exterior, removable cover may encapsulate the entire mattress 504 or only a portion of it, such as, for example, the top portion. The exterior, removable cover may fasten to a portion of mattress 504 or to a portion of foundation 510 via mechanical fasteners such as zippers, buttons, hook and clasp fasteners, ties, or any other fastener or fastening method that allows the cover to be removed and replaced. In some embodiments, the removable cover may fasten to itself instead of or in addition to the mattress 504 and/or the foundation 510.

In certain embodiments, mattress 504 may include one or more fire-retardant, liquid-resistant, or allergy-resistant layers. One or more of these layers may be placed adjacent to the innercore 502 on its top surface, bottom surface, and/or one or more side surfaces. In some embodiments, one or more of these layers may be placed adjacent to a surface of a padding layer or a topper pad in the mattress 504. In some embodiments, the layers may be accessible via an opening in the top surface of the housing. The opening may allow a user to insert, remove, or replace one or more layers via the opening. The user may experience the compression of the innercore 502 with different layers placed adjacent the innercore 502 on its top surface, bottom surface, and/or one or more side surfaces.

The one or more fire-retardant layers may comprise a fire barrier fabric or laminate that complies with regulatory requirements for flammability, such as the California Bureau of Home Furnishings Technical Bulletin 129 Flammability Test Procedure, the entirety of which is hereby incorporated by reference. In certain embodiments, a fire-retardant layer may be quiltable. The one or more liquid-resistant or allergy-resistant layers may comprise a coated or uncoated fabric or laminate material. The liquid-resistant or allergy-resistant layer may be breathable and quiltable. The various layers detailed above may be fastened to each other in a number of ways. For example, layers may be attached to each other along the edges, in the center, between the edges and the center, or some combination of the above. Attachment may be done via stitching, quilting, adhesives, or fastening via mechanical fasteners.

Mattress assembly 500 includes a mounted mattress display device 506. Mattress display device 506 may be fabricated of a flexible material, such as plastic, paper, or fabric, and may be disposed on mattress 504 at its head, foot, along its sides, or anywhere on the mattress 504. Mattress display device 506 may be configured to be flexible and to drape down at least partially along the sides of mattress assembly 500, as shown in FIGS. 5A-B. In some embodiments, mattress display device 506 may include one or more information regions or labels. The labels may provide information about the mattress or cushioning article technology contained within the mattress assembly 500. For example, a label may include the name, technical specifications, and/or a description of the properties of the mattress 504, innercore 502, and/or the foundation 510. The information in the labels may be written and/or drawn directly onto a surface of the mattress display device 506, or may be contained in a sticker, tag, or other information sheet that may be attached to a surface of the mattress display device 506.

The mattress display device 506 includes at least one attachment support 508, which allows other items to be attached to the mattress display device 506. In certain embodiments, the attachment support 508 may not be integral with the mattress display device 506, and may instead attach to the mattress display device 506 via hook-and-loop fasteners or other types of fasteners, such as magnetic fasteners, buttons, zippers, adhesives, or any other reversible or permanent attachment method. For example, a portion of the attachment support 508 may tuck beneath a portion 512 of the mattress display device 506. The portion 512 of the mattress display device 506 may include a portion of a complementary fastener, such as the hook portion or the loop portion of a hook-and-loop fastener, and may attach to the portion of the attachment support 508 which tucks beneath the portion 512.

In certain embodiments, the attachment support 508 may include an attachment portion 514 for attaching to an accessory or item. For example, the attachment portion 514 may include a portion of a hook-and-loop fastener, such as the hook portion or the loop portion, for attaching to the complementary portion of the hook-and-loop fastener disposed on an accessory or item to be attached to the attachment support 508. In other embodiments, attachment support 508 may include other types of fasteners, such as magnetic fasteners, buttons, zippers, adhesives, or any other reversible or permanent attachment method.

FIG. 5B depicts a cross-section view of mattress assembly 500, with innercore 502 (not shown here). The mattress display device 506 may include two layers, a top layer 520 and a lower layer 522. In certain embodiments, the top layer 520 may have a smaller area than the lower layer 522, such that the top layer 520 does not cover the entire top and side surfaces of the lower layer 522. In some embodiments, the top layer 520 and/or the lower layer 522 may include one or more information regions or labels. The labels may provide information about the mattress or cushioning article technology contained within the mattress assembly 500. For example, a label may include the name, technical specifications, and/or a description of the properties of the mattress 504, innercore 502 (FIG. 5A), and/or the foundation 510. The information in the labels may be written and/or drawn directly onto a surface of the top layer 520 and/or the lower layer 522, or may be contained in a sticker, tag, or other information sheet that may be attached to a surface of the top layer 520 and/or the lower layer 522.

In some embodiments, the top layer 520 may attach to the lower layer 522 via one or more fasteners, such as hook-and-loop fasteners, magnetic fasteners, buttons, zippers, adhesives, or any other reversible or permanent attachment method. In other embodiments, the top layer 520 may not be attached to the lower layer 522 at all.

The mattress display device 506 may also include one or more mattress attachments 524, for attaching the mattress display device to the mattress assembly 500. Mattress attachments 524 may be flat structures made of a flexible material, such as fabric and/or plastic, and may be sized and shaped to be smaller than the lower layer 522 of the mattress display device 506. In some embodiments, the mattress attachments may be polyester fly sheets. In one embodiment, the mattress attachments 524 are configured to tuck in between the mattress 504 and the foundation 510. The mattress attachments 524 may be integral to the mattress display device 506, or may be separate and configured to attach to the mattress display device 506. For example, the mattress attachments 524 may attach to the mattress display device 506 via one or more fasteners, such as hook-and-loop fasteners, magnetic fasteners, buttons, zippers, adhesives, or any other reversible or permanent attachment method.

In some embodiments, the bottom surface of the mattress display device 506 and/or the lower layer 522 may be a surface receptive to a hook-and-loop fastener. For example, parts of the bottom surface may have a texture similar to the hook portion or the loop portion of a hook- and loop fastener. In some embodiments, the entire bottom surface may have this texture. The attachment support 508 (FIG. 5A) and/or a portion of the mattress attachments 524 may be configured with the appropriate fastener complement to fasten to the bottom surface. For example, if the bottom surface has a loop texture, the attachment support 508 and/or the mattress attachments 524 may have a hook texture or hook fasteners to attach to the bottom surface. The entire surface of mattress attachments 524 exposed to the bottom surface of lower layer 522 may be configured to attach to the bottom surface. In other embodiments, only a portion of the mattress attachments 524 may be configured to attach to the bottom surface. For example, in one embodiment, only the top portions of mattress attachments 524 (i.e., the portions of mattress attachments 524 that lie on the top surface of mattress 504) may be configured to attach to the bottom surface of lower layer 522. In this embodiment, the parts of the lower layer 522 that drape down may not be held against the mattress 504, and may be free to move. While two mattress attachments 524 are shown in FIG. 5B, fewer or more mattress attachments may be used. For example, a single mattress attachment 524 may be used, with a length and/or width similar to the length and/or width of the lower layer 522 of the mattress display device 506.

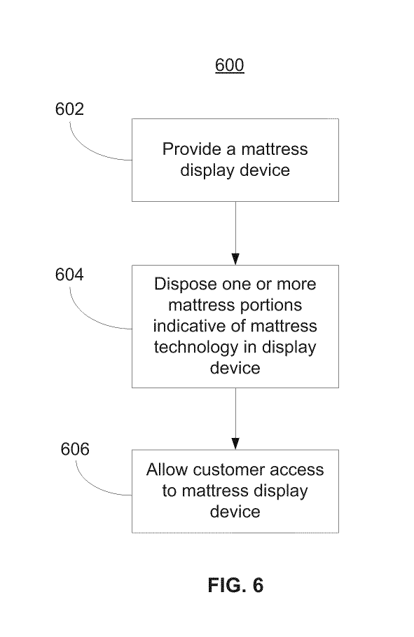

FIG. 6 is a flowchart depicting a process 600 for providing a mattress display device, according to an illustrative embodiment. In step 602, one or more mattress display devices, such as the mattress display devices 100 (FIG. 1), 200 (FIG. 2A), 250 (FIG. 2B), 300 (FIG. 3), 400 (FIG. 4), or 506 (FIG. 5) may be provided. In step 604, one or more mattress portions indicative of mattress technology is disposed in or near the mattress display device(s). These mattress portions may include coil springs, foam, upholstery, fire-retardant/moisture-resistant layers, or any other mattress/cushioning article components. In some embodiments, combinations of any of these mattress/cushioning article components may be disposed in or near the mattress display device(s). In step 606, customers are allowed access to the mattress display device(s), so that they can physically touch, compress, and/or actuate the mattress portions disposed in or near the mattress display device(s).

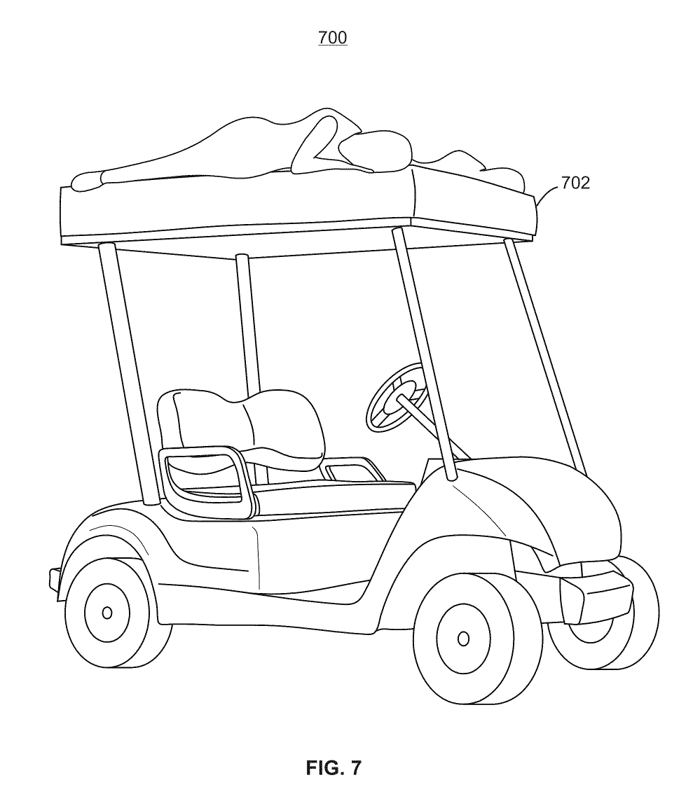

In some embodiments, any of the mattress display devices 100 (FIG. 1), 200 (FIG. 2A), 250 (FIG. 2B), 300 (FIG. 3), 400 (FIG. 4), or 506 (FIG. 5) may be disposed as free-standing display devices, or may be attached to another supporting or exhibiting structure, such as a shelf or table. In other embodiments, any of these mattress devices may be attached in, on, or to a mobile supporting or exhibiting structure, such as a portable displays, automobiles, golf carts, or any other mobile structure, whether self-propelled or not. FIG. 7 shows a mattress display device 702 disposed on the roof of a golf cart 700. The golf cart is a mobile exhibiting structure for the mattress display device, mattress display device 702. A user may experience visual and tactile responses related to a mattress by, for example, touching the mattress display device 702, and/or compressing one or more portions of the mattress display device 702. The mattress display device 702 may be large enough to allow a user to lie on the mattress display device. In some embodiments, multiple mattress display devices may be mounted on golf cart 700.

Variations, modifications, and other implementations of what is described may be employed without departing from the spirit and scope of the disclosure. More specifically, any of the method, system, and device features described above or incorporated by reference may be combined with any other suitable method, system, or device features disclosed herein or incorporated by reference, and is within the scope of the contemplated systems and methods described herein. The systems and methods may be embodied in other specific forms without departing from the spirit or essential characteristics thereof. The foregoing embodiments are therefore to be considered in all respects illustrative, rather than limiting of the systems and methods described herein. The teachings of all references cited herein are hereby incorporated by reference in their entirety.

1. A mattress display device for providing visual and tactile responses related to a mattress to a customer, comprising:
a mattress;
a housing, having a front substantially transparent surface, a back surface, a top surface, a bottom surface, and side surfaces extending between the front and back surfaces and the top and bottom surfaces, wherein the top surface includes an opening;
a mounting flange extending outwardly from at least one of the back surface and the side surfaces, the mounting flange configured to attach to a portion of the mattress;
a plurality of coil springs similar to one or more coil springs in the mattress, each having a top end and a bottom end, the coil springs being disposed within the housing such that the bottom ends of the plurality of coil springs are in substantially the same plane and the coil springs are arranged adjacent to one another, wherein the opening in the top surface exposes the top end of at least one of the plurality of coil springs to the customer; and
a rigid panel sized to slide through the opening in the top surface and formed from rigid material capable of compressing one or more coil springs, thereby allowing the customer to experience the visual and tactile responses related to the mattress.

2. The mattress display device of claim 1, wherein the side surfaces have a width corresponding to two or more coil springs placed beside each other.

3. The mattress display device of claim 1, further comprising:
a label disposed on at least one of the housing, the plurality of coil springs, and the rigid panel, the label comprising at least one of a name of a technology, a technical specification of the technology, and a description of a property of the technology.

4. The mattress display device of claim 1, wherein the mounting flange is inserted between the mattress and a foundation of a mattress assembly, the mattress being disposed on the foundation.

5. The mattress display device of claim 1, further comprising:
a plunger disposed within the housing, the plunger having a base, a spring activated stem attached to the base for movement relative to the base, and a coil spring disposed on the plunger, wherein the plunger is configured to allow the customer to compress the top end of the coil spring by operating the plunger.

6. The mattress display device of claim 1, further comprising:
at least one of a fire-retardant layer, a liquid-resistant layer, and an allergy-resistant layer disposed on the plurality of coil springs, wherein the layers are accessible via the opening in the top surface of the housing, thereby allowing the customer to remove or replace one or more layers via the opening.

7. The mattress display device of claim 1, wherein one or more foam blocks are disposed within the housing and the opening in the top surface exposes a top end of at least one of the foam blocks to the customer.

8. The mattress display device of claim 1, wherein the plurality of coil springs comprises at least one of an open coil spring, an encased coil spring, and an asymmetric coil spring.

9. The mattress display device of claim 1, wherein the plurality of coil springs is less than number of coil springs in the mattress.

10. The mattress display device of claim 1, wherein the plurality of coil springs comprises at least one coil spring having a height different from the rest of the coil springs.

11. The mattress display device of claim 1, wherein the plurality of coil springs comprises a matrix of coil springs arranged in rows and columns.

12. The mattress display device of claim 1, wherein the rigid panel comprises at least one edge curved to mimic the shape of a prone human body.

13. The mattress display device of claim 1, further comprising a storage slot for storing the rigid panel.

14. The mattress display device of claim 1, wherein the rigid panel is formed from at least one of plastic, wood, and cardboard.

15. A mattress display device for providing visual and tactile responses related to a mattress to a customer, comprising:
a housing, having a top substantially transparent surface, a bottom surface, a front surface, a back surface, and side surfaces extending between the top and bottom surfaces and the front and back surfaces; and
a plurality of coil springs similar to one or more coil springs in a mattress and less than number of coils in the mattress, each having a top end and a bottom end, the coil springs being disposed within the housing such that the plurality of coil springs are arranged in rows and columns,
wherein the top surface includes an opening to expose the top end of at least one of the plurality of coil springs to the customer.

16. A method for of allowing a user to experience visual and tactile responses related to a mattress to a customer, comprising:
providing a mattress;
disposing a housing on a side of the mattress, the housing having a front substantially transparent surface, a back surface, a top surface, a bottom surface, and side surfaces extending between the front and back surfaces and the top and bottom surfaces, wherein the top surface includes an opening; and
disposing a plurality of coil springs similar to one or more coil springs in the mattress within the housing, each having a top end and a bottom end, wherein the opening in the top surface exposes the top end of at least one of the plurality of coil springs to the customer.

17. The method of claim 16, further comprising:
disposing a label on at least one of the housing and the plurality of coil springs, the label comprising at least one of a name of a technology, a technical specification of the technology, and a description of a property of the technology.

18. The method of claim 16, wherein the housing is disposed on a side of the mattress by inserting a mounting flange between the mattress and a foundation of a mattress assembly, the mounting flange disposed on the housing and extending outwardly from at least one of the back surface and the side surfaces of the housing.

19. The method of claim 16, further comprising:
allowing the customer to experience the visual and tactile responses related to the mattress by compressing the plurality of coil springs disposed in the housing with a rigid panel, the rigid panel sized to slide through the opening in the top surface and formed from rigid material capable of compressing one or more coil springs.

20. The method of claim 16, further comprising:
disposing a plunger within the housing, the plunger having a base and a spring activated stem attached to the base for movement relative to the base,
disposing a coil spring on the plunger, and
allowing the customer to compress the top end of the coil spring by operating the plunger.

21. The method of claim 16, further comprising:
disposing at least one of a fire-retardant layer, a liquid-resistant layer, and an allergy-resistant layer on the plurality of coil springs, the layers being accessible via the opening in the top surface of the housing; and
allowing the customer to remove or replace one or more layers via the opening.

22. The method of claim 16, further comprising disposing one or more foam blocks within the housing, such that the opening in top surface exposes a top end of at least one foam block to the customer.
